(19) United States
(12) Patent Application Publication
(10) Pub. No.: US 2018/0205115 A1
(43) Pub. Date: Jul. 19, 2018

(54) LITHIUM ION SECONDARY BATTERY

(71) Applicant: HITACHI CHEMICAL COMPANY, LTD., Tokyo (JP)

(72) Inventors: Eisuke HABA, Chiyoda-ku, Tokyo (JP); Kenji TAKAOKA, Chiyoda-ku, Tokyo (JP); Hiroki KUZUOKA, Chiyoda-ku, Tokyo (JP); Shunsuke NAGAI, Chiyoda-ku, Tokyo (JP); Takuya NISHIMURA, Chiyoda-ku, Tokyo (JP)

(21) Appl. No.: 15/744,370

(22) PCT Filed: Jul. 20, 2016
(86) PCT No.: PCT/JP2016/071309

§ 371 Date: Jan. 12, 2018

(30) Foreign Application Priority Data
Jul. 23, 2015 (JP) 2015-145840
Jul. 23, 2015 (JP) 2015-145948

(51) Int. Cl. H01M 10/0525; H01M 4/66; H01M 4/04; H01M 10/04; H01M 10/0565; H01M 2/18; H01M 2/02

(52) U.S. Cl. CPC H01M 10/0525; H01M 4/661; H01M 4/0404; H01M 2004/028; H01M 10/0565; H01M 2/18; H01M 2/022; H01M 10/0459

(57) ABSTRACT

A lithium ion secondary battery includes a positive electrode, a negative electrode, and a separator, and the positive electrode includes a current collector, a conductive layer formed on the current collector, and a positive electrode active material layer formed on the conductive layer, the conductive layer includes a conductive particle, a polymer particle, and a water-soluble polymer, and the separator has a heat shrinkage ratio at 160° C. of 30% or less, or the separator includes a porous substrate and an inorganic particle, and the porous substrate includes a layered body in which polypropylene and polyethylene are alternately layered, or the separator includes an inorganic particle and a porous substrate including a woven or non-woven fabric of polyethylene terephthalate.

### TECHNICAL FIELD

The present invention relates to a lithium ion secondary battery.

### BACKGROUND ART

Lithium ion secondary batteries, which are an energy device having a high energy density, are widely used as a power source of a portable information terminal such as a notebook type personal computer, a cellular phone, or a PDA.

In typical lithium ion secondary batteries, a positive electrode and a negative electrode are alternately layered via a separator to form an electrode group. As a negative electrode active material, a carbon material having a multilayer structure capable of inserting and releasing a lithium ion between layers is mainly used. As a positive electrode active material, a lithium-containing composite metal oxide is mainly used. As a separator, a polyolefin porous film is mainly used. Lithium ion secondary batteries composed of such a material have high battery capacity and output, and favorable charge and discharge cycle characteristics.

The safety of lithium ion secondary batteries is also high. On the other hand, lithium ion secondary batteries are demanded to further improve in terms of safety because of their high capacity and high output. For example, when lithium ion secondary batteries are overcharged, there is a possibility of heat generation or thermal runaway. Therefore, the method of Patent Document 1 has been proposed as a method for cutting off a current and suppressing heat generation. In Patent Document 1, it is disclosed that, by providing a PTC layer containing a conductive particle, a polymer particle, and a water-soluble polymer on a positive electrode current collector, when the temperature of a lithium ion secondary battery rises, the internal resistance of the lithium ion secondary battery is increased to make it difficult for current to flow, and an effect of suppressing overheating of the lithium ion secondary battery is exhibited.

### RELATED ART DOCUMENT

### Patent Document

Patent Document 1 International Publication WO 2015/046469

### SUMMARY OF INVENTION

### Technical Problem

However, it has been found that the lithium ion secondary battery described in Patent Document 1 does not exhibit sufficiently higher safety when a temperature rise due to overcharge or the like occurs.

The invention has been made in view of the above problems, and an object thereof is to provide a lithium ion secondary battery that is excellent in current blocking property when overcharging occurs and has high volume energy density.

### Solution to Problem

Specific measures for achieving the above object are as follows.

<1> A lithium ion secondary battery, comprising:

a positive electrode;

a negative electrode; and

a separator, wherein:

the positive electrode comprises a current collector, a conductive layer formed on the current collector, and a positive electrode active material layer formed on the conductive layer,

the conductive layer comprises a conductive particle, a polymer particle, and a water-soluble polymer, and

the separator has a heat shrinkage ratio at 160° C. of 30% or less.

<2> The lithium ion secondary battery according to <1>, wherein the separator comprises a porous substrate and an inorganic particle, the porous substrate comprises two or more different resins, and the two or more different resins are selected from the group consisting of polypropylene, polyethylene, polyvinyl alcohol, polyethylene terephthalate, polyacrylonitrile, and aramid.

<3> The lithium ion secondary battery according to <2>, wherein the porous substrate comprises polyethylene and polypropylene.

<4> The lithium ion secondary battery according to <1>, wherein a Gurley value of the separator is 1,000 sec/100 cc or less.

<5> The lithium ion secondary battery according to <1> or <4>, wherein the separator comprises a porous substrate and an inorganic particle, and the porous substrate comprises polyester.

<6> The lithium ion secondary battery according to <5>, wherein the polyester comprises polyethylene terephthalate.

<7> The lithium ion secondary battery according to any one of <1> to <6>, wherein the polymer particle comprises a polyethylene particle.

<8> The lithium ion secondary battery according to any one of <1> to <7>, wherein a content ratio of a mixture of particles comprising the conductive particle and the polymer particle, and the water-soluble polymer, is from 99.9:0.1 to 95:5 in terms of mass ratio (mixture of particles:water-soluble polymer).

<9> The lithium ion secondary battery according to any one of <1> to <8>, wherein a content ratio of the conductive particle and the polymer particle is from 2:98 to 20:80 in terms of mass ratio (conductive particle:polymer particle).

<10> A lithium ion secondary battery, comprising:

a positive electrode;

a negative electrode; and

a separator, wherein:

the positive electrode comprises a current collector, a conductive layer formed on the current collector, and a positive electrode active material layer formed on the conductive layer,

the conductive layer comprises a conductive particle, a polymer particle, and a water-soluble polymer, and

the separator comprises a porous substrate and an inorganic particle, and the porous substrate comprises a layered body in which polypropylene and polyethylene are alternately layered.

<11> A lithium ion secondary battery, comprising:

a positive electrode;

a negative electrode; and

a separator, wherein:

the positive electrode comprises a current collector, a conductive layer formed on the current collector, and a positive electrode active material layer formed on the conductive layer,

the conductive layer comprises a conductive particle, a polymer particle, and a water-soluble polymer, and

the separator comprises an inorganic particle and a porous substrate including a woven or non-woven fabric of polyethylene terephthalate.

<12> The lithium ion secondary battery according to any one of <2>, <3>, <5>, <6>, <10>, or <11>, wherein the inorganic particle is at least one of aluminum oxide (Al₂O₃) or silicon oxide (SiO₂).

<13> The lithium ion secondary battery according to any one of <2>, <3>, <5>, <6>, or <10> to <12>, wherein the separator comprises a layer containing the inorganic particle on one surface of the porous substrate, and the layer containing the inorganic particle faces the positive electrode.

<14> The lithium ion secondary battery according to any one of <1> to <13>, wherein the separator has a thickness of from 5 μm to 100

<15> The lithium ion secondary battery according to any one of <1> to <14>, wherein the conductive layer has a thickness of from 0.1 μm to 10 μm.

### Advantageous Effects of Invention

According to the invention, a lithium ion secondary battery that is excellent in current blocking property when overcharging occurs and has high volume energy density can be provided.

### BRIEF DESCRIPTION OF DRAWINGS

FIG. 1 shows a cross-sectional view of a lithium ion secondary battery to which the present disclosure is applied.

### DESCRIPTION OF EMBODIMENTS

Preferred embodiments of the invention will be described below. Matters other than those specifically mentioned herein and needed for implementation of the invention can be grasped as design items of those skilled in the art based on conventional art in the relevant field. The invention can be carried out based on the contents disclosed herein and technical common sense in the field. In the following drawings, the same reference numerals are attached to the same members or parts having the same function, and redundant explanation may be omitted or simplified. The dimensional relationship (length, width, thickness, and the like) in the drawings does not reflect the actual dimensional relationship.

Herein, numerical values described before and after “to” are included as the minimum value and the maximum value, respectively, in the numerical range indicated by “to”. Within stepwise numerical ranges described herein, the upper limit value or the lower limit value described in one numerical range may be replaced with the upper limit value or the lower limit value of another stepwise numerical range. In the numerical range described herein, the upper limit value or the lower limit value of the numerical value range may be replaced with values illustrated in Examples.

Herein, unless otherwise specified, the content of each component in a composition means the total content of a plurality of kinds of substances present in the composition when the plurality of kinds of substances corresponding to each component exist in the composition.

Herein, unless otherwise specified, the particle size of each component in a composition means a value for a mixture of a plurality of kinds of particles present in the composition when the plurality of kinds of particles corresponding to each component exist in the composition.

The technique of the invention can be widely applied to a variety of kinds of non-aqueous electrolyte secondary batteries provided with an electrode in which an electrode active material is held by a current collector. In this kind of battery, by interposing a conductive layer according to the technique of the invention between a current collector and an electrode active material layer, an electric resistance between the current collector and the electrode active material layer can be increased when the temperature of the battery rises and an effect of suppressing overheating of the battery can be exhibited.

Hereinafter, the invention will be described in more detail mainly by taking a positive electrode including the conductive layer between a positive electrode active material layer including a positive electrode active material and a current collector, and a lithium ion secondary battery including the positive electrode, but there is no intention to limit a subject to which the invention is applied to such an electrode or battery.

The first lithium ion secondary battery of the disclosure is a lithium ion secondary battery including a positive electrode, a negative electrode, and a separator, wherein the positive electrode includes a current collector, a conductive layer formed on the current collector, and a positive electrode active material layer formed on the conductive layer, the conductive layer includes a conductive particle, a polymer particle, and a water-soluble polymer, and the separator has a heat shrinkage ratio at 160° C. of 30% or less.

The second lithium ion secondary battery of the disclosure is a lithium ion secondary battery including a positive electrode, a negative electrode, and a separator, wherein the positive electrode includes a current collector, a conductive layer formed on the current collector, and a positive electrode active material layer formed on the conductive layer, the conductive layer includes a conductive particle, a polymer particle, and a water-soluble polymer, and the separator includes a porous substrate and an inorganic particle, and the porous substrate includes a layered body in which polypropylene and polyethylene are alternately layered.

The third lithium ion secondary battery of the disclosure is a lithium ion secondary battery, including a positive electrode, a negative electrode, and a separator, wherein the positive electrode includes a current collector, a conductive layer formed on the current collector, and a positive electrode active material layer formed on the conductive layer, the conductive layer includes a conductive particle, a polymer particle, and a water-soluble polymer, and the separator includes an inorganic particle and a porous substrate including a woven or non-woven fabric of polyethylene terephthalate.

Hereinafter, the first lithium ion secondary battery, the second lithium ion secondary battery, and the third lithium ion secondary battery may be collectively referred to as “lithium ion secondary battery of the disclosure”.

(Positive Electrode)

A positive electrode includes a current collector, a conductive layer formed on the current collector, and a positive electrode active material layer formed on the conductive layer. The positive electrode may be a layered body in which a positive electrode active material layer, a conductive layer, and a current collector (positive electrode current collector) are layered in this order. The conductive layer includes a conductive particle, a polymer particle, and a water-soluble polymer, and is formed as an aggregate of the conductive particle, the polymer particle, and the water-soluble polymer.

By using a water-soluble polymer for a conductive layer, a conductive particle is easily distributed uniformly in the conductive layer, and therefore a conductive network which is an electron transfer path is formed substantially uniformly over the conductive layer. When a water-soluble polymer is used for a conductive layer, the adhesive force between a positive electrode current collector and a conductive layer and between a positive electrode active material layer and a conductive layer is improved.

When the conductive layer is an aggregate of a conductive particle, a polymer particle, and a water-soluble polymer, the conductive particle is a conductive inorganic particle, the polymer particle is a nonconductive and thermoplastic resin particle, and furthermore, the thickness of the conductive layer is small, the output characteristics of a lithium ion secondary battery using the positive electrode having this conductive layer is further improved.

In other words, when the distance of movement of electrons in the conductive layer is short, the response of electron transfer from the positive electrode active material layer to the positive electrode current collector becomes more uniform. As a result, the discharge rate characteristics (hereinafter, sometimes referred to as “output characteristics”) are further improved. From the above viewpoint, the thickness of the conductive layer is preferably 10 μm or less, more preferably 8 μm or less, and still more preferably 6 μm or less. The lower limit value of the thickness of the conductive layer is not particularly limited, and from the viewpoint of film forming property, the value is preferably 0.1 μm or more, more preferably 1 μm or more, still more preferably 2 μm or more, and particularly preferably 3 μm or more.

In one embodiment, the thickness of the conductive layer is, from the viewpoint of compatibility of battery characteristics and a PTC function, preferably from 0.1 μm to 10 μm, more preferably from 1 μm to 10 still more preferably from 2 μm to 8 μm, and particularly preferably from 3 μm to 6 μm.

The conductive layer of the disclosure not only improves the output characteristics but also has a function (hereinafter, sometimes referred to as “PTC function”) of suppressing further heat generation since the current flow in the conductive layer is interrupted when the conductive layer reaches a predetermined temperature due to heat generation.

As described above, the positive electrode is composed of a positive electrode current collector, a conductive layer, and a positive electrode active material layer, and is arranged in such a manner to face a negative electrode via a separator.

As the positive electrode current collector, those commonly used in the field of lithium ion secondary batteries can be used, and examples thereof include a sheet, a foil, or the like containing stainless steel, aluminum, titanium, or the like.

Among these, a sheet or foil containing aluminum is preferred. The thickness of the sheet and foil is not particularly limited, and the thickness is, from the viewpoint of ensuring the strength and processability needed for the current collector, preferably from 1 μm to 500 μm, more preferably from 2 μm to 80 μm, and still more preferably from 5 μm to 50 μm.

As described above, the conductive layer is an aggregate of a mixture of a conductive particle, a polymer particle, and a water-soluble polymer. By deforming the aggregate at a preset temperature (hereinafter, referred to as “current blocking temperature” in some cases), the current is interrupted and further heat generation is suppressed. The current blocking temperature can be appropriately set by selecting the type of a polymer particle, the content of a polymer particle, and the like The conductive layer is formed on one or both surfaces in the thickness direction of the positive electrode current collector.

Examples of the conductive particle include carbon particles such as graphite, acetylene black, Ketjen black, channel black, furnace black, lamp black, or thermal black, metal particles such as nickel particles, a metal carbide such as WC, B₄C, ZrC, NbC, MoC, TiC, or TaC, a metal nitride such as TiN, ZrN, or TaN, and a metal silicide such as WSi₂ or MoSi₂. Among these, carbon particles and metal particles are preferable, and carbon particles are more preferable. Conductive particles may be used singly, or may be used in combination of two or more as necessary. Conductive particles having a PTC function may be used as the conductive particles, and examples thereof include an alkaline earth metal titanate salt such as barium titanate, barium strontium titanate, or barium lead titanate, and a solid solution in which dissimilar metals are dissolved in an alkaline earth metal titanate.

When carbon particles are used as the conductive particles, the average particle size of primary particles constituting the carbon particles is, from the viewpoint of further improving battery characteristics, preferably from 10 nm to 500 nm, more preferably from 15 nm to 200 nm, and still more preferably from 20 nm to 100 nm.

As the conductive particles, acetylene black having a structure in which primary particles are continuous to some degree is particularly preferable. The degree (degree of structure development) of continuous primary particles of acetylene black is preferably, for example, a shape factor of about from 5 to 50 calculated by dividing the average length of chains of primary particles by the average particle size of the primary particles.

Examples of the polymer particle include particles of nonconductive and thermoplastic resin. Examples of such polymer particles include particles of polyethylene, polypropylene, ethylene-vinyl acetate copolymer (EVA), polyvinyl chloride, polyvinylidene chloride, polyvinyl fluoride, polyvinylidene fluoride, polyamide, polystyrene, polyacrylonitrile, thermoplastic elastomer, polyethylene oxide, polyacetal, thermoplastic modified cellulose, polysulfones, or polymethyl (meth) acrylate. Among these, polyolefin particles such as polyethylene or polypropylene are preferable. The polymer particles may be used singly, or may be used in combination of two or more as necessary. Herein, “(meth) acrylate” means at least one of acrylate and methacrylate.

The average particle size of the polymer particles is not particularly limited, and is, from the viewpoint of further improving battery characteristics, preferably from 0.1 μm to 5 μm, and more preferably from 0.2 μm to 4 μm.

The smaller the average particle size of polyolefin particles, the more the positive electrode active material layer tends to be uniformly formed on the positive electrode current collector, and the larger the average particle size of the polyolefin particles, the more the battery characteristics tend to be improved.

The content ratio of the conductive particle and the polymer particle is not particularly limited, and is preferably from 2:98 to 20:80 based on mass ratio (conductive particle:polymer particle), more preferably from 3:97 to 15:85 based on mass ratio, and still more preferably from 5:95 to 10:90 based on mass ratio. When the content ratio of the conductive particle is 2 or more, an electron transfer path in the conductive layer is sufficiently secured, and the output characteristics of the battery tend to be improved. When the content ratio of the conductive particle is 20 or less, the PTC function is sufficiently exhibited, and the responsiveness of the current interruption to heat generation tends to be improved.

For example, the average particle size of the conductive particle and the polymer particle can be a numerical value obtained by arithmetically averaging the values of the long side lengths of all the particles within an image of transmission electron micrograph of the range of 10 μm in length×10 μm in width in a central part of a current collector in which a conductive layer of about 5 μm was formed by coating an aqueous dispersion slurry of the conductive particle, the polymer particle, and the water-soluble polymer on a current collector and removing water.

Examples of the water-soluble polymer include a carboxymethyl cellulose derivative such as carboxymethyl cellulose or carboxymethyl cellulose sodium salt, polyvinyl alcohol, polyvinyl pyrrolidone, a water-soluble alginic acid derivative, gelatin, carrageenan, glucomannan, pectin, curdlan, gellan gum, polyacrylic acid, and a polyacrylic acid derivative. Among these, a carboxymethyl cellulose derivative, polyvinyl alcohol, polyvinyl pyrrolidone, and polyacrylic acid are preferable, and a carboxymethyl cellulose derivative is more preferable. The content ratio of a mixture of particles containing the conductive particle and the polymer particle and the water-soluble polymer is not particularly limited, and the content ratio is preferably from 99.9:0.1 to 95:5 in terms of mass ratio (mixed particles:water-soluble polymer), more preferably from 99.5:0.5 to 98:3, and still more preferably from 99.5:0.5 to 98:2. When the content ratio of the water-soluble polymer is 0.1 or more, the dispersion of the conductive particle is sufficient, an electron transfer path in the conductive layer is sufficiently secured, and the battery characteristics tend to be improved. When the content ratio of the water-soluble polymer is 5 or less, the viscosity of the resulting dispersion tends not to be high, and the coatability to a current collector tends to be improved.

In the disclosure, the water-soluble polymer preferably has a weight average molecular weight of 1,000 or more. From the viewpoint of the dispersibility of the conductive particle, the weight average molecular weight of the water-soluble polymer is more preferably 5,000 or more, still more preferably 10,000 or more, and particularly preferably 50,000 or more.

The weight average molecular weight of a carboxymethyl cellulose derivative which is a water-soluble polymer can be calculated from a calibration curve using pullulan as a standard substance, for example, by connecting GPC column (GL-W560 manufactured by Hitachi High-Technologies Corporation) to an HPLC system equipped with a differential refractometer (RID-10A manufactured by Shimadzu Corporation) as a detector, using 0.2 M NaCl aqueous solution as a mobile phase at a flow rate of 1.0 mL/min to perform molecular measurement.

The weight average molecular weights of polyvinyl alcohol, polyvinyl pyrrolidone, and polyacrylic acid which are water-soluble polymers can be measured, for example, by connecting a GPC column (model number W550 manufactured by Hitachi Chemical Co., Ltd.) to an HPLC pump (model number L-7100 manufactured by Hitachi High-Technologies Corporation) equipped with a differential refractometer (model number L-3300 manufactured by Hitachi High-Technologies Corporation) and using 0.3 M NaCl as a mobile phase.

The viscosity (60 rpm) at 25° C. when a water-soluble polymer is made into a 1% aqueous solution is preferably from 100 mPa·s to 8,000 mPa·s, more preferably from 500 mPa·s to 6,000 mPa·s, and still more preferably from 1,000 mPa·s to 4,000 mPa·s.

The current blocking temperature of the conductive layer is preferably set to from 70° C. to 140° C., and more preferably set to from 90° C. to 120° C. By setting the current blocking temperature of the conductive layer to from 70° C. to 140° C., when an abnormality occurs in a battery itself or a variety of kinds of equipment in which a battery is mounted, it is possible to interrupt the current, suppress heat generation, and stop the supply of electric power from the battery to a variety of devices, and therefore, a very high safety is obtained. When the current blocking temperature is set to from 90° C. to 120° C., the further advantages are obtained that there is no erroneous operation during normal use, and that the current can be reliably blocked at the time of an abnormality such as overcharging. The current blocking temperature depends on the melting point of the polymer particle. When the current blocking temperature is set to from 90° C. to 120° C., polyethylene particle is preferably used as the polymer particle.

The positive electrode active material layer is formed on one or both surfaces in the thickness direction of the positive electrode current collector, contains a positive electrode active material, and may further contain a conductive material, a binder, and the like, as necessary. As the positive electrode active material, those commonly used in this field can be used, examples thereof include lithium-containing composite metal oxide, olivine-type lithium salt, chalcogen compound, and manganese dioxide. The lithium-containing composite metal oxide is a metal oxide containing lithium and a transition metal or a metal oxide in which a part of the transition metal in the metal oxide is substituted by a different element. Here, examples of the different element include Na, Mg, Sc, Y, Mn, Fe, Co, Ni, Cu, Zn, Al, Cr, Pb, Sb, V, and B, and Mn, Al, Co, Ni, Mg, and the like are preferable. The different element may be used singly, or may be used in combination of two or more as necessary.

Among these, a lithium-containing composite metal oxide is preferable. Examples of the lithium-containing composite metal oxide include LiₓCoO₂, LiₓNiO₂, LiₓMnO₂, LiₓCo_{y}N_{1-y}O₂, LiₓCo_{y}M¹_{1-y}O, (in LiₓCo_{y}M¹_{1-y}O_{z}, M¹ represents at least one element selected from the group consisting of Na, Mg, Sc, Y, Mn, Fe, Ni, Cu, Zn, Al, Cr, Pb, Sb, V, and B), LiₓNi_{1-y}M²_{y}O_{z} (in LiₓNi_{1-y}M²_{y}O_{z}, M² represents at least one element selected from the group consisting of Na, Mg, Sc, Y, Mn, Fe, Co, Cu, Zn, Al, Cr, Pb, Sb, V, and B), LiₓMn₂O₄, LiₓMn_{2-y}M³_{y}O₄ (in LiₓMn_{2-y}M³_{y}O₄, M³ represents at least one element selected from the group consisting of Na, Mg, Sc, Y, Fe, Co, Ni, Cu, Zn, Al, Cr, Pb, Sb, V, and B). Here, x is in the range of 0<x≤1.2, y is in the range of from 0 to 0.9, and z is in the range of from 2.0 to 2.3. The x value indicating the molar ratio of lithium increases or decreases with charge and discharge.

Examples of the olivine-type lithium salt include LiFePO₄. Examples of the chalcogen compound include titanium disulfide and molybdenum disulfide. Examples of another positive electrode active material include Li₂MPO₄F (in Li₂MPO₄F, M represents at least one element selected from the group consisting of Na, Mg, Sc, Y, Mn, Fe, Co, Ni, Cu, Zn, Al, Cr, Pb, Sb, V, and B). The positive electrode active material may be used singly, or may be used in combination of two or more kinds thereof as necessary.

As the conductive material which may be used for the positive electrode active material layer, for example, carbon black, graphite, carbon fiber, metal fiber, or the like can be used. Examples of carbon black include acetylene black, Ketjen black, channel black, furnace black, lamp black, and thermal black. Examples of graphite include natural graphite and artificial graphite. The conductive material may be used singly, or may be used in combination of two or more kinds thereof as necessary.

Examples of the binder which may be used for the positive electrode active material layer include polyethylene, polypropylene, polyvinyl acetate, polymethyl methacrylate, nitrocellulose, fluororesin, and rubber particles.

Examples of the fluororesin include polytetrafluoroethylene (PTFE), polyvinylidene fluoride (PVDF), tetrafluoroethylene-hexafluoropropylene copolymer (FEP), and vinylidene fluoride-hexafluoropropylene copolymer.

Examples of the rubber particles include styrene-butadiene rubber particles and acrylonitrile rubber particles.

Among them, in view of improving the oxidation resistance of the positive electrode active material layer, a binder containing fluorine is preferable. The binder may be used singly, or may be used in combination of two or more kinds thereof as necessary.

The positive electrode active material layer can be formed, for example, by coating a positive electrode mixture paste on a conductive layer, drying, and rolling if necessary. The positive electrode mixture paste can be prepared by adding a positive electrode active material to a dispersion medium together with a binder, a conductive material, and the like and mixing them. As the dispersion medium, for example, N-methyl-2-pyrrolidone (NMP), tetrahydrofuran, dimethylformamide, or the like can be used. It is preferable to select a dispersion medium that does not dissolve a polymer particle contained in the conductive layer. Some polymer particles are hardly soluble in both organic solvents and water, and when such polymer particles are used, the kind of dispersion medium is not limited.

In the lithium ion secondary battery of the disclosure, upon formation of a positive electrode active material layer including a positive electrode active material, a conductive material, and a binder as described above, when the packing density of the positive electrode active material layer becomes too high, a nonaqueous electrolytic solution hardly permeates into the positive electrode active material layer, and diffusion of lithium ions at the time of charge and discharge at a large current is delayed, possibly resulting in deterioration in cycle characteristics. On the other hand, when the packing density of the positive electrode active material layer is low, sufficient contact between the positive electrode active material and the conductive material can not be secured, and therefore, the electrical resistance increases and the discharge rate may decrease. For this reason, the packing density (positive electrode mixture density) of the positive electrode active material layer is preferably in the range of from 2.2 g/cm³ to 2.8 g/cm³, more preferably from 2.3 g/cm³ to 2.7 g/cm³, and still more preferably from 2.4 g/cm³ to 2.6 g/cm³.

In the lithium ion secondary battery of the disclosure, upon preparation of a positive electrode by coating a positive electrode active material layer on a positive electrode current collector, when the coating amount of the positive electrode active material layer is increased and the positive electrode active material layer becomes too thick, unevenness of reaction may occur in the thickness direction and cycle characteristics may be deteriorated when charging and discharging with a large current. On the other hand, when the positive electrode active material layer is too thin due to a small coating amount of the positive electrode active material layer, a sufficient battery capacity may be not obtained. For this reason, the coating amount of the positive electrode active material layer to the conductive layer is preferably in the range of from 50 g/m² to 300 g/m², more preferably in the range of from 80 g/m² to 250 g/m², and still more preferably in the range of from 100 g/m² to 220 g/m².

From the viewpoints of discharge capacity and discharge rate, the thickness of the positive electrode active material layer is preferably from 30 μm to 200 μm, more preferably from 50 μm to 180 μm, and still more preferably from 70 μm to 150 μm.

(Negative Electrode)

A negative electrode is provided in such a manner to face the positive electrode with a separator interposed therebetween, and includes a negative electrode current collector and a negative electrode active material layer. Examples of the negative electrode current collector include a sheet and a foil including stainless steel, nickel, copper, or the like. The thickness of the sheet and the foil is not particularly limited, and is, from the viewpoint of securing the strength and processability needed for the current collector, preferably from 1 μm, to 500 μm, more preferably from 2 μm to 100 μm, and still more preferably from 5 μm to 50 μm. The negative electrode active material layer is formed on one or both surfaces in the thickness direction of the negative electrode current collector, contains a negative electrode active material, and may further contain a binder, a conductive material, a thickener, or the like as necessary.

As the negative electrode active material, materials commonly used in the field of lithium ion secondary batteries which can occlude and release lithium ions can be used. Examples thereof include metallic lithium, a lithium alloy, an intermetallic compound, a carbon material, an organic compound, an inorganic compound, a metal complex, and an organic polymer compound. Negative electrode active material may be used singly, or may be used in combination of two or more kinds thereof as necessary. Among these, a carbon material is preferable. Examples of the carbon material include graphite such as natural graphite (scaly graphite or the like) or artificial graphite, carbon black such as acetylene black, Ketjen black, channel black, furnace black, lamp black, or thermal black, and carbon fiber. The average particle size of the carbon material is preferably from 0.1 μm to 60 μm, and more preferably from 0.5 μm to 30 μm. The BET specific surface area of the carbon material is preferably from 1 m²/g to 10 m²/g. In particular, from the viewpoint of further improving battery characteristics, among carbon materials, graphite having an interval (d₀₀₂) of carbon hexagonal planes of 3.35 Å to 3.40 Å and a crystallite (Lc) of c axis direction of 100 Å or more is preferable.

Among carbon materials, amorphous carbon having an interval (d₀₀₂) of carbon hexagonal planes in the X-ray wide angle diffraction method of from 3.5 Å to 3.95 Å is particularly preferable from the viewpoint of further improving cycle characteristics and safety.

Herein, the average particle size of the negative electrode active material is defined as the 50% integration value (median diameter (D50)) from the small diameter side of a volume-based particle size distribution of a sample dispersed in purified water containing a surfactant measured by a laser diffraction-type particle size distribution measuring apparatus (for example, SALD-3000J manufactured by Shimadzu Corporation).

The BET specific surface area can be measured, for example, from the nitrogen adsorption ability in accordance with JIS Z 8830:2013. As an evaluation device, for example, AUTOSORB-1 (trade name) manufactured by Quantachrome Corporation can be used. When measuring the BET specific surface area, it is considered that moisture adsorbed in the sample surface and the structure affects the gas adsorption ability, and therefore it is preferable to perform a pretreatment for removal of moisture by heating in advance.

In the pretreatment, after lowering a measuring cell charged with 0.05 g of measurement sample with a vacuum pump to 10 Pa or less, the cell is heated at 110° C., held for 3 hours or more, and then naturally cooled to room temperature (25° C.) while maintaining the reduced pressure state. After this pretreatment, measurement is carried out at an evaluation temperature of 77 K and the evaluation pressure range is less than 1 at relative pressure (equilibrium pressure with respect to saturated vapor pressure).

As the conductive material which may be used for the negative electrode active material layer, a conductive material similar to the conductive material contained in the positive electrode active material layer can be used. As a binder which may be used for the negative electrode active material layer, those normally used in the field of lithium ion secondary batteries can be used. Examples thereof include polyethylene, polypropylene, polytetrafluoroethylene, polyvinylidene fluoride, styrene butadiene rubber, and acrylic rubber. Examples of the thickener which may be used for the negative electrode active material layer include carboxymethyl cellulose. The negative electrode active material layer can be formed, for example, by applying a negative electrode mixture paste to the surface of a negative electrode current collector, drying, and rolling if necessary. The negative electrode mixture paste can be prepared, for example, by adding a negative electrode active material to a dispersion medium together with a binder, a conductive material, a thickener, and the like if necessary and mixing them. As the dispersion medium, for example, N-methyl-2-pyrrolidone (NMP), water, or the like can be used.

(Electrolyte)

Examples of the electrolyte include a liquid nonaqueous electrolyte, a gel nonaqueous electrolyte, and a solid electrolyte (such as a polymeric solid electrolyte). The liquid nonaqueous electrolyte contains a solute (supporting salt) and a nonaqueous solvent, and further contains a variety of additives if necessary. The solute is usually dissolved in a nonaqueous solvent. The liquid nonaqueous electrolyte is impregnated in, for example, a separator.

As the solute, those commonly used in this field can be used, and examples thereof include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lower aliphatic lithium carboxylic acid, LiCl, LiBr, LiI, chloroborane lithium, borate salts, and imide salts. Examples of borate salts include lithium bis(1,2-benzenediolate(2-)-O,O′) borate, lithium bis(2,3-naphthalenediolate(2-)-O,O′) borate, lithium bis(2,2′-biphenyldiolate(2-)-O,O′) borate, and lithium bis(5-fluoro-2-oleate-1-benzenesulfonic acid-O,O′) borate. Examples of imide salts include lithium bistrifluoromethanesulfonate imide ((CF₃SO₂)₂NLi), lithium trifluoromethanesulfonate nonafluorobutanesulfonate imide ((CF₃SO₂) (C₄F₉SO₂)NLi), and lithium bispentafluoroethane sulfonate imide ((C₂F₅SO₂)₂NLi). The solute may be used singly, or may be used in combination of two or more kinds thereof as necessary. The amount of a solute dissolved in a nonaqueous solvent is preferably from 0.5 mol/L to 2 mol/L.

As the nonaqueous solvent, those commonly used in this field can be used, and examples thereof include a cyclic carbonic acid ester, a chain carbonic acid ester, and a cyclic carboxylic acid ester. Examples of the cyclic carbonic acid ester include propylene carbonate (PC), and ethylene carbonate (EC). Examples of the chain carbonic acid ester include diethyl carbonate (DEC), ethyl methyl carbonate (EMC), and dimethyl carbonate (DMC). Examples of the cyclic carboxylic acid ester include γ-butyrolactone (GBL) and γ-valerolactone (GVL). The nonaqueous solvent may be used singly, or may be used in combination of two or more kinds thereof as necessary.

From the viewpoint of further improving the battery characteristics, it is preferable to contain vinylene carbonate (VC) in the nonaqueous solvent.

In the case of containing vinylene carbonate (VC), the content thereof is preferably from 0.1% by mass to 2% by mass, more preferably from 0.2% by mass to 1.5% by mass, based on the total amount of the nonaqueous solvent.

(Separator)

A separator is arranged between a positive electrode and a negative electrode.

A first separator used in the disclosure has a heat shrinkage ratio at 160° C. of 30% or less.

A second separator used in the disclosure includes a porous substrate and an inorganic particle, and the porous substrate includes a layered body in which polypropylene and polyethylene are alternately layered.

A third separator used in the disclosure includes an inorganic particle and a porous substrate including a woven or non-woven fabric of polyethylene terephthalate.

Hereinafter, the first separator, the second separator, and the third separator may be collectively referred to as “separator of the disclosure”.

The first separator may have a heat shrinkage ratio at 160° C. of 30% or less, preferably 20% or less, more preferably 10% or less, still more preferably 7% or less, and particularly preferably 2% or less. When the heat shrinkage ratio of the first separator at 160° C. is 30% or less, the occurrence of short-circuiting between the positive electrode and the negative electrode can be suppressed since the shape of the first separator is maintained even when the battery temperature rises in an overcharged state and the separator is thermally shrunk.

The heat shrinkage ratios of the second separator and the third separator are not limited, and may be, for example, 30% or less, preferably 20% or less, more preferably 10% or less, still more preferably 7% or less, and particularly preferably 2% or less.

The lower limit of the heat shrinkage ratio at 160° C. is preferably 0%, and, from a practical viewpoint, the lower limit is 1% or more.

Herein, heat treatment in an oven at 160° C. for 60 minutes is performed on a separator having a length of 30 mm (MD) and a width of 30 mm (TD), and from measured values of the length of the separator before and after the heat treatment, the heat shrinkage ratio at 160° C. is determined as follows.

heat shrinkage ratio (%)=(length before heat treatment(TD)−length after heat treatment(TD))/length before heat treatment(TD)×100

The TD direction means a direction perpendicular to a take-up direction (lateral direction) at the time of film production, and the MD direction means the take-up direction.

Herein, a separator which is cut into a size of 30 mm in length (MD) and 30 mm in width (TD) is sandwiched between two glass substrates, heat-treated in an oven at 160° C. for 60 minutes, the areas of the separator before and after the heat treatment are calculated, and the heat shrinkage ratio of the separator at 160° C. may be obtained as follows.

heat shrinkage ratio(area shrinkage ratio) (%)=(area before heating-area after heating)/area before heating×100

The Gurley value [sec/100 cc] of the separator of the disclosure may be 1,000 sec/100 cc or less, 800 sec/100 cc or less, 600 sec/100 cc or less, 300 sec/100 cc or less, 200 sec/100 cc or less, or 100 sec/100 cc or less.

The Gurley value [sec/100 cc] of the separator of the disclosure may be from 1 sec/100 cc to 1,000 sec/100 cc, from 1 sec/100 cc to 800 sec/100 cc, from 1 sec/100 cc to 600 sec/100 cc, from 1 sec/100 cc to 300 sec/100 cc, from 1 sec/100 cc to 200 sec/100 cc, or from 1 sec/100 cc to 100 sec/100 cc.

When the Gurley value of the separator of the disclosure is within the range of from 1 sec/100 cc to 300 sec/100 cc, the ion permeability is favorable, and the discharge rate characteristics tend to be excellent.

The Gurley value is an air permeability resistance calculated by the Gurley test method, and represents the difficulty of passing through ions in the thickness direction of a separator. Specifically, the Gurley value is expressed as the time required for 100 cc ions to pass through the separator. This means that when the numerical value of the Gurley value is small, it is easy for ions to pass through, and when the numerical value is large, it is difficult for ions to pass through.

In the specification, the Gurley value is a value measured according to the Gurley test method (JIS P8117:2009).

A fourth lithium ion secondary battery of the disclosure is a lithium ion secondary battery including a positive electrode, a negative electrode, and a separator, wherein the positive electrode includes a current collector, a conductive layer formed on the current collector, and a positive electrode active material layer formed on the conductive layer, the conductive layer includes a conductive particle, a polymer particle, and a water-soluble polymer, and a Gurley value of the separator is 300 sec/100 cc or less. The heat shrinkage ratio of the separator according to the fourth lithium ion secondary battery is not limited, and may be, for example, 30% or less, preferably 20% or less, more preferably 10% or less, still more preferably 7% or less, and particularly preferably 2% or less.

The separator of the disclosure may include a porous substrate and an inorganic particle.

Examples of the resin contained in the porous substrate include an olefine based resin such as polypropylene or polyethylene, a fluorocarbon resin such as polytetrafluoroethylene, a polyester such as polyethylene terephthalate (PET), aramid, polyacrylonitrile, polyvinyl alcohol, or polyimide. The porous substrate may be used singly, or may be used in combination of two or more kinds thereof as necessary.

In one embodiment, the separator contains a porous substrate and an inorganic particle, the porous substrate contains two or more different resins, and the resin may be selected from the group consisting of polypropylene, polyethylene, polyvinyl alcohol, polyethylene terephthalate, polyacrylonitrile, and aramid, and preferably contains polyethylene and polypropylene.

In one embodiment, the separator may contain a porous substrate and an inorganic particle, and the porous substrate may contain a polyester. Among the polyesters contained in the porous substrate, polyethylene terephthalate (PET) is suitable as a porous substrate since it is excellent in heat resistance and electrical insulation. When the resin contained in the porous substrate is polyethylene terephthalate, it is preferable to use a woven or non-woven fabric of polyethylene terephthalate as the porous substrate. In the specification, “non-woven fabric” means a sheet-like object formed by entangling fibers without weaving.

When the porous substrate contains two or more kinds of resins, a structure in which two or more kinds of resins are alternately layered may be used. In the disclosure, when the porous substrate has a structure in which two or more resins are layered, it is preferable that the porous substrate has a two-layer structure or a three-layer structure.

The method for producing the porous substrate is not particularly limited, and can be selected from known methods. In the disclosure, the porous substrate may be a woven fabric or a non-woven fabric, and is preferably a non-woven fabric.

The melting point of the porous substrate is preferably 120° C. or more, more preferably 140° C. or more, and still more preferably 160° C. or more. When the melting point is 120° C. or higher, the separator has a shutdown function, and a short circuit inside the battery can also be prevented. The upper limit of the melting point of the porous substrate is not particularly limited, and from the practical point of view, the melting point of the porous substrate is preferably 300° C. or lower.

Herein, the melting point is measured by conducting differential scanning calorimetry of a sample of from 3 mg to 5 mg tightly sealed in an aluminum pan under the condition of a heating rate of 10° C./min, a measurement temperature range of 25° C. to 350° C., and a flow rate of 20±5 mL/min under a nitrogen atmosphere, using differential scanning calorimeter (DSC7 manufactured by PerkinElmer, Inc.). From the results obtained from the differential scanning calorimetry, the temperature (endothermic reaction peak) at which the energy change accompanying the phase transition occurs is taken as the melting point.

Examples of the inorganic particle include aluminum oxide (Al₂O₃), silicon oxide (SiO₂), titanium oxide (TiO₂), barium titanate (BaTiO₃), ZrO₂ (zirconia), and boehmite. Inorganic particles may be used singly, or may be used in combination of two or more as necessary.

From the viewpoint of electrical insulation or electrical stability, it is preferable to use at least one of aluminum oxide (hereinafter, also referred to as “alumina”) and silicon oxide (hereinafter, also referred to as “silica”).

The inorganic particle has a function of protecting a porous substrate in such a manner that the porous substrate does not thermally deform or heat shrink while maintaining the shutdown function of the porous substrate which melts due to abnormally high temperature of the battery. The inorganic particles may be coated on the surface of the porous substrate, or may be impregnated in pores of the porous substrate.

A separator may be provided in such a manner that a layer containing an inorganic particle is provided on one surface of the porous substrate, and the layer containing the inorganic particle is opposed to a positive electrode. The layer containing the inorganic particle can function as a heat resistant layer for protecting the porous substrate from thermal deformation or heat shrinkage.

When two or more resins are used for the porous substrate, two different types of resins may be alternately layered, or a layered body formed by alternately layering polypropylene and polyethylene may be used.

When a porous substrate having a three-layer structure is used as a separator, a preferable combination in the porous substrate having a three-layer structure is a layered body of a porous film containing resins having different melting temperatures, more preferably a combination of porous substrates containing an olefine based resin, and still more preferably, those obtained by layering polypropylene/polyethylene/polypropylene (hereinafter, sometimes referred to as “PP/PE/PP”) in this order. By using the above combination of porous substrates, the separator has a shutdown function and is also excellent in electrochemical stability, which is preferable.

In the disclosure, a separator obtained by a manufacturing method in which one obtained by layering PP/PE/PP in this order is used as a porous substrate and aluminum oxide or silicon oxide is attached to the porous substrate of PP/PE/PP may be used.

Since the polyethylene layer is sandwiched between the polypropylene layers by this three-layer structure, even when the polyethylene layer melts, the inorganic particle present on the surface of the porous substrate or impregnated in the pores exhibit the function as a heat resistant layer, and maintain the separating function between a positive electrode and a negative electrode. In addition, since polyethylene melts and does not flow out, the shutdown function is efficiently exhibited. When further exposed to high temperatures, polypropylene melts in the temperature range of from 160° C. to 170° C., and polyethylene and polypropylene close pores of the porous substrate, and therefore, a safer shutdown function is exhibited.

The average particle size (D50) of the inorganic particle is preferably from 0.1 μm to and more preferably from 0.2 μm to 9 μm. When the average particle size of the inorganic particle is within the above range, the adhesion between the inorganic particle and the porous substrate is favorable, and even when the battery temperature rises, the thermal shrinkage of the separator decreases.

Herein, the average particle size of the inorganic particle is defined as the 50% integration value (median diameter (D50)) from the small diameter side of a volume-based particle size distribution of a sample dispersed in purified water containing a surfactant measured by a laser diffraction-type particle size distribution measuring apparatus (for example, SALD-3000) manufactured by Shimadzu Corporation).

The ratio (α1:β1) based on mass of the content (α1) of the inorganic particle in the separator of the disclosure and the content (β1) of a resin such as polyethylene terephthalate is, from the viewpoint of the thermal shrinkage factor, flexibility, or the like of the separator, preferably in the range of from 1:50 to 20:1, more preferably in the range of from 1:25 to 10:1, and still more preferably in the range of from 1:5 to 4:1.

When the inorganic particle is coated on the porous substrate, the ratio (α2:β2) of the thickness (α2) of the layer of the inorganic particle (hereinafter, referred to as “inorganic particle layer”) to the thickness (β2) of the porous substrate is, from the viewpoint of the thermal shrinkage factor, flexibility, or the like of the separator, preferably in the range of from 1:100 to 10:1, more preferably in the range of from 1:50 to 5:1, and still more preferably in the range of from 1:10 to 2:1.

In one embodiment, the thickness of the separator is preferably in the range of from 5 μm to 100 μm, more preferably in the range of from 7 μm to 50 μm, and still more preferably in the range of from 15 μm to 30 μm. In another embodiment, the thickness of the separator is preferably in the range of from 5 μm to 100 μm, more preferably in the range of from 13 μm to 70 μm, and still more preferably in the range of from 15 μm to 50 μm.

When the thickness of the separator is in the range of from 5 μm to 100 μm, excellent volume energy density and safety can be obtained while maintaining ion permeability.

Hereinafter, an embodiment in which the disclosure is applied to a laminate battery will be described.

A laminate-type lithium ion secondary battery can be prepared, for example, as follows. First, a positive electrode and a negative electrode are cut into square shapes, and tabs are welded to the respective electrodes to prepare positive electrode and negative electrode terminals. An electrode layered body is prepared by layering a positive electrode and a negative electrode, and a separator interposed therebetween, the electrode layered body in this state is accommodated in a laminate pack made of aluminum, the positive electrode and negative electrode terminals are put outside the aluminum laminate pack, and the laminate pack is sealed. Next, the nonaqueous electrolytic solution is poured into the aluminum laminate pack and the opening of the aluminum laminate pack is sealed. By this, a lithium ion secondary battery can be obtained.

Next, an embodiment in which the disclosure is applied to a cylindrical lithium ion secondary battery of 18650 type will be described with reference to the drawings.

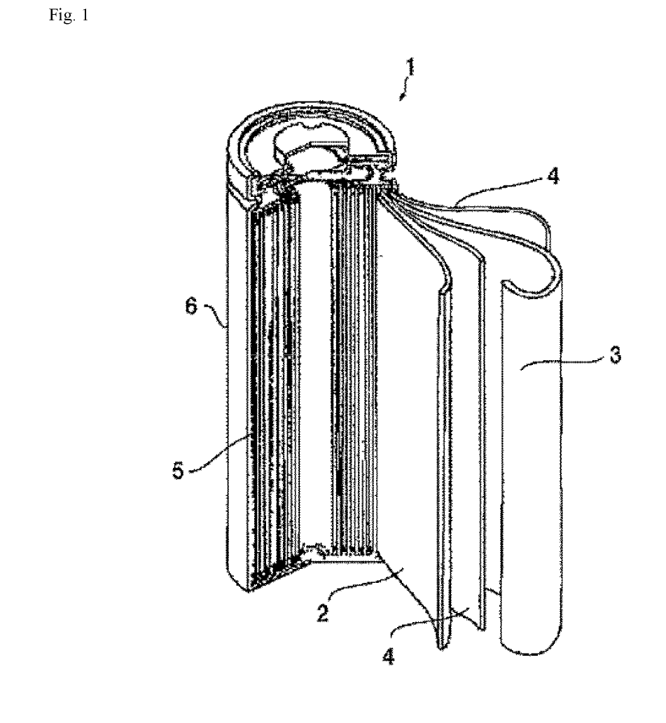

FIG. 1 shows a cross-sectional view of a lithium ion secondary battery to which the disclosure is applied.

As illustrated in FIG. 1, a lithium ion secondary battery 1 of the disclosure includes a battery container 6 with a bottomed cylindrical shape made of nickel-plated steel. In the battery container 6, an electrode group 5 is accommodated, in which a strip-shaped positive electrode plate 2, a strip-shaped negative electrode plate 3, and a separator 4 interposed therebetween, are wound in a spiral shape in cross section. For example, the separator 4 has a width of 58 mm and a thickness of 30 μm. On the upper end face of the electrode group 5, a ribbon-like positive electrode tab terminal made of aluminum and having one end fixed to the positive electrode plate 2 is led out. The other end of the positive electrode tab terminal is joined to the lower surface of a disk-shaped battery lid which is arranged on the upper side of the electrode group 5 and is to be a positive electrode external terminal by ultrasonic welding. On the other hand, on the lower end face of the electrode group 5, a ribbon-shaped copper negative electrode tab terminal having one end fixed to the negative electrode plate 3 is led out. The other end of the negative electrode tab terminal is joined to the inner bottom portion of the battery container 6 by resistance welding. Therefore, the positive electrode tab terminal and the negative electrode tab terminal are respectively led out to opposite sides on both end faces of the electrode group 5. An insulating cover (not illustrated) is applied to the entire circumference of the outer peripheral surface of the electrode group 5. The battery lid is caulked and fixed to the upper part of the battery container 6 via an insulating resin gasket. For this reason, the interior of the lithium ion secondary battery 1 is hermetically sealed. A nonaqueous electrolytic solution (not illustrated) is injected into the battery container 6.

### EXAMPLES

Hereinafter, the invention will be described based on Examples. The invention is not limited to the following Examples.

### Experimental Example 1A

### (1) Preparation of Conductive Layer

Acetylene black (a conductive particle, trade name: HS-100, average particle size 48 nm (catalog value of Denki Kagaku Kogyo Co., Ltd., manufactured by Denki Kagaku Kogyo Co., Ltd.), a polyethylene particle (a polymer particle, trade name: Chemipearl (registered trademark) W400, average particle size 4 μm (catalog value of Mitsui Chemicals, Inc., manufactured by Mitsui Chemicals, Inc.), and carboxymethyl cellulose (CMC, manufactured by Daicel Corporation, #2200) were mixed in such a manner that the solid content mass ratio (acetylene black:the polyethylene particle:CMC) was 5:94:1, and uniformly dispersed. Water was added to the resulting mixture to prepare a conductive layer slurry. This conductive layer slurry was coated on both surfaces of a 15 μm thick aluminum foil (positive electrode current collector, manufactured by Mitsubishi Aluminum Company, Ltd.), and dried at 60° C. to prepare a conductive layer with a thickness of 5 μm.

### (2) Preparation of Positive Electrode Plate

The positive electrode plate was prepared as follows. Acetylene black (average particle size 50 nm) as a conductive material and polyvinylidene fluoride (PVDF) as a binder were sequentially added to a layered lithium-nickel-manganese-cobalt composite oxide which is a positive electrode active material, and they were mixed to prepare a positive electrode mixture paste.

The content of the positive electrode active material, acetylene black, and a binder was set to 90:5.5:4.5 for positive electrode active material: acetylene black: binder.

Further, N-methyl-2-pyrrolidone (NMP) which is a dispersion solvent was added to the positive electrode mixture paste, and the mixture was kneaded to form a slurry. This slurry was applied substantially uniformly and homogeneously on the surfaces of the conductive layers provided on both surfaces of an aluminum foil having a thickness of 15 μm. Thereafter, the plate was subjected to a drying treatment, and consolidated by pressing to a predetermined density. The positive electrode mixture density was 2.60 g/cm³, and the coating amount on one side of the positive electrode mixture was 140 g/m².

### (3) Preparation of Negative Electrode Plate

A negative electrode plate was prepared as follows. Polyvinylidene fluoride (PVDF) as a binder was added to easily graphitizable carbon (d₀₀₂=0.35 nm, average particle size (D50)=18 μm) as a negative electrode active material. These mass ratio was set to 92:8 for the negative electrode active material: binder. N-methyl-2-pyrrolidone (NMP) as a dispersion solvent was added thereto, and the mixture was kneaded to form a slurry. This slurry was applied substantially uniformly and homogenously to both surfaces of a rolled copper foil having a thickness of 10 μm which is a current collector for a negative electrode. The negative electrode mixture density was 1.15 g/cm³, and the coating amount on one side of the negative electrode mixture was 90 g/m².

### (4) Preparation of 18650 Type Battery

An electrode group was prepared by winding the prepared positive electrode and negative electrode, with a separator, configured by a polypropylene/polyethylene/polypropylene three-layer porous substrate having a thickness of 30 μm and a width of 58.5 mm and coated with silica (hereinafter, also referred to as a “coating type PP/PE/PP separator”), interposed therebetween. In the preparation, the electrode group was designed in such a manner that the capacity of the battery was 900 mAh. The electrode group was inserted into a battery container, and the negative electrode tab terminal previously welded to the negative electrode current collector was welded to the bottom of a can. Next, the positive electrode tab terminal previously welded to the positive electrode current collector was welded in such a manner to be electrically connected to the positive electrode external terminal, the positive electrode cap was arranged on the upper part of the can, and an insulating gasket was inserted.

A heat resistant layer containing silica was formed on one side of the porous substrate of a coating type PP/PE/PP separator, and was arranged in such a manner that the heat resistant layer faced the positive electrode when the coating type PP/PE/PP separator was interposed between the positive electrode and the negative electrode.

The heat shrinkage ratio (area shrinkage ratio) of the coating type PP/PE/PP separator was measured by the above method and found to be 18%.

After that, a nonaqueous electrolytic solution in which 0.8% by mass of vinylene carbonate with respect to the total amount of the mixed solution was added to ethylene carbonate/ethyl methyl carbonate/dimethyl carbonate=2/2/3 mixed solution (volume ratio) containing 1.2 M LiPF₆ was used. Six milliliters of the nonaqueous electrolytic solution was injected into the battery container. The top of the battery container was then caulked to seal the battery. In this way, an 18650 type lithium ion secondary battery was prepared.

### Experimental Example 2A

An 18650 type battery was prepared in a similar manner to Experimental Example 1A except that a polyethylene particle (a polymer particle, trade name: Chemipearl (registered trademark) W300, average particle size 3 μm (catalog value of Mitsui Chemicals, Inc.), manufactured by Mitsui Chemicals, Inc.) was used instead of the polyethylene particle (a polymer particle, trade name: Chemipearl (registered trademark) W400, average particle size 4 μm (catalog value of Mitsui Chemicals, Inc.), manufactured by Mitsui Chemicals, Inc.).

### Experimental Example 3A

An 18650 type battery was prepared in a similar manner to Experimental Example 1A except that a polyethylene particle (a polymer particle, trade name: Chemipearl (registered trademark) WP100, average particle size 1 μm (catalog value of Mitsui Chemicals, Inc.), manufactured by Mitsui Chemicals, Inc.) was used instead of the polyethylene particle (a polymer particle, trade name: Chemipearl (registered trademark) W400, average particle size 4 μm (catalog value of Mitsui Chemicals, Inc.), manufactured by Mitsui Chemicals, Inc.).

### Experimental Example 4A

An 18650 type battery was prepared in a similar manner to Experimental Example 1A except that a conductive layer was not provided on the surface of the positive electrode current collector.

### Experimental Example 5A

An 18650 type battery was prepared in a similar manner to Experimental Example 4A except that a polyethylene (PE) separator having a thickness of 30 μm was used and a conductive layer was not provided on the surface of the positive electrode current collector.

The heat shrinkage ratio (area shrinkage ratio) of the polyethylene separator was measured by the above method and found to be 98%.

### Experimental Example 6A

An 18650 type battery was prepared in a similar manner to Experimental Example 1A except that a polyethylene separator having a thickness of 30 μm was used.

[Evaluation of Overcharge Property]

The 18650 type batteries obtained in Experimental Examples 1A to 6A were subjected to an overcharge test under a constant current condition of 3 CA (2.7 A) in an atmosphere at 25° C. As the overcharging progresses, the battery temperature rises, and accordingly, a polymer particle in a conductive layer dissolve, and the internal resistance rises. A large overvoltage occurs due to a rise in the internal resistance. At this time, the voltage of the battery was profiled, and the highest attained voltage before thermal runaway was obtained according to the following criteria, and this was regarded as overcharge property. The higher this value, the higher the internal resistance of the battery, exhibiting favorable current blocking property and excellent safety.

A: 6.1 V or more
B: from 5.5 V to less than 6.1 V
C: less than 5.5 V

[Evaluation of Volume Energy Density]

With respect to the 18650 type batteries obtained in Experimental Examples 1A to 6A, the volume energy density based on discharge capacity at 25° C. was measured using a charge-discharge device (TOYO SYSTEM Co., LTD., trade name: TOSCAT-3200) under the following charge and discharge conditions, and the volume energy density was determined. Batteries with overcharge test results A to C were charged at constant current (CC) up to 4.2 V at 0.5 C and then charged to 0.01 C at constant voltage (CV). Next, constant current (CC) discharge was carried out at 0.5 C up to 3 V, and the volume energy density at the time of discharge was evaluated according to the following evaluation criteria. C means “current value (A)/battery capacity (Ah)”.

A: 235 Wh/dm³ or more
B: from 225 Wh/dm³ to less than 235 Wh/dm³
C: less than 225 Wh/dm³

TABLE 1

| | | Experimental | Experimental | Experimental | Experimental | Experimental | Experimental |
|---|---|---|---|---|---|---|---|
| | | Example 1A | Example 2A | Example 3A | Example 4A | example 5A | Example 6A |
| Composition | Film thickness of | 5 | 5 | 5 | 0 | 0 | 5 |
| of | conductive layer | | | | | | |
| conductive | (μm) | | | | | | |
| layer | Melting point of | 110 | 132 | 148 | — | — | 110 |
| | polyolefin | | | | | | |
| | particle (° C.) | | | | | | |
| | Particle size of | 4 | 3 | 1 | — | — | 4 |
| | polyolefin | | | | | | |
| | particle (μm) | | | | | | |
| Composition | Material (porous | PP/PE/PP | PP/PE/PP | PP/PE/PP | PP/PE/PP | PE | PE |
| of separator | substrate) | | | | | | |
| | Film thickness | 30 | 30 | 30 | 30 | 30 | 30 |
| | (μm) | | | | | | |
| | Heat shrinkage | 18 | 18 | 18 | 18 | 98 | 98 |
| | ratio (%) | | | | | | |
| Safety | Overcharge | A | A | A | C | C | B |
| | property | | | | | | |
| Battery | Volume energy | A | A | A | C | C | B |
| property | density | | | | | | |

Experimental Examples 1A to 3A having a coating type PP/PE/PP separator and a conductive layer were found to have excellent effects on overcharge property and volume energy density.

This is thought to be due to in addition to the PTC function of the conductive layer, the fact that since the coating type PP/PE/PP separator is a three layer separator, the temperature at which the separator melts down is risen to about 160° C., and the fact that since the surface of the separator is coated with silica, the short circuit area when the separator melts down is reduced.

On the other hand, Experimental Example 4A without a conductive layer and Experimental Example 5A without a conductive layer and using a separator made of polyethylene were found to have inferior overcharge property and volume energy density. It was found that Experimental Example 6A having a conductive layer and using a separator made of polyethylene was superior to experimental Examples 4A and 5A, and was inferior to Experimental Examples 1A to 3A.

### Experimental Example 1B

An 18650 type lithium ion secondary battery was prepared in a similar manner to Experimental Example 1A except that a separator having a heat resistant layer in which alumina and silica are mixed in a polyethylene terephthalate non-woven fabric having a thickness of 28 μm and a width of 58.5 mm (hereinafter, sometimes referred to as “polyethylene terephthalate non-woven fabric” or “PET non-woven fabric”) was used instead of the coating type PP/PE/PP separator in Experimental Example 1A.

The Gurley value of the PET non-woven fabric was measured by the above-described method and found to be 20 sec/100 cc. The heat shrinkage ratio (area shrinkage ratio) of the PET non-woven fabric was measured by the above-described method and found to be 2%.

### Experimental Example 2B

An 18650 type battery was prepared in a similar manner to Experimental Example 1B except that a polyethylene particle (a polymer particle, trade name: Chemipearl (registered trademark) W300, average particle size 3 μm (catalog value of Mitsui Chemicals, Inc.), manufactured by Mitsui Chemicals, Inc.) was used instead of the polyethylene particle (a polymer particle, trade name: Chemipearl (registered trademark) W400, average particle size 4 μm (catalog value of Mitsui Chemicals, Inc.), manufactured by Mitsui Chemicals, Inc.).

### Experimental Example 3B

An 18650 type battery was prepared in a similar manner to Experimental Example 1B except that a polyethylene particle (a polymer particle, trade name: Chemipearl (registered trademark) WP100, average particle size 1 μm (catalog value of Mitsui Chemicals, Inc.), manufactured by Mitsui Chemicals, Inc.) was used instead of the polyethylene particle (a polymer particle, trade name: Chemipearl (registered trademark) W400, average particle size 4 μm (catalog value of Mitsui Chemicals, Inc.), manufactured by Mitsui Chemicals, Inc.).

### Experimental Example 4B

An 18650 type battery was prepared in a similar manner to Experimental Example 1B except that a conductive layer was not provided on the surface of the positive electrode current collector.

### Experimental Example 5B

An 18650 type battery was prepared in a similar manner to Experimental Example 4B except that a polyethylene (PE) separator having a thickness of 30 μm and a Gurley Value of 600 sec/100 cc was used and a conductive layer was not provided on the surface of the positive electrode current collector.

The Gurley Value of the polyethylene separator was measured by the above-described method. The heat shrinkage ratio (area shrinkage ratio) of the polyethylene separator was measured by the above method and found to be 98%.

### Experimental Example 6B

An 18650 type battery was prepared in a similar manner to Experimental Example 1B except that a polyethylene separator having a thickness of 30 μm and a Gurley Value of 600 sec/100 cc was used.

[Evaluation of Overcharge Property]

The overcharge property of the 18650 type batteries obtained in Experimental Examples 1B to 6B were evaluated in a similar manner to Experimental Examples 1A to 6A. The evaluation criteria were changed as follows.

A: 7 V or more
B: from 6.1 V to less than 7 V
C: from 5.5 V to less than 6.1 V
D: from 4.8 V to less than 5.5 V
E: less than 4.8 V

(Evaluation of Battery Property)

### [Evaluation of Volume Energy Density]

With respect to the 18650 type batteries obtained in Experimental Examples 1B to 6B, the volume energy density and discharge rate characteristics based on discharge capacity at 25° C. were measured using a charge-discharge device (TOYO SYSTEM Co., LTD., trade name: TOSCAT-3200) under the following charge and discharge conditions, and the battery property was determined. A battery with the result of the overcharge property A was charged at a constant current (CC) up to 4.3 V at 0.5 C, and then charged up to 0.01 C at a constant voltage (CV). Batteries with overcharge test result B were charged at a constant current (CC) up to 4.25 V at 0.5 C, and then charged up to 0.01 C at a constant voltage (CV). A battery with overcharge test result C was charged at a constant current (CC) up to 4.2 V at 0.5 C, and then charged up to 0.01 C at a constant voltage (CV). Batteries with overcharge test results D and E were charged at a constant current (CC) up to 4.1 V at 0.5 C, and then charged up to 0.01 C at a constant voltage (CV). Next, constant current (CC) discharge was carried out at 0.5 C to 3 V, and the volume energy density at the time of discharge was evaluated according to the following evaluation criteria. C means “current value (A)/battery capacity (Ah)”.

A: 245 Wh/dm³ or more
B: from 235 Wh/dm³ to less than 245 Wh/dm³
C: from 225 Wh/dm³ to less than 235 Wh/dm³
D: less than 225 Wh/dm³

[Evaluation of Discharge Rate Characteristics]

A battery with overcharge test result A was charged at a constant current (CC) up to 4.3 V at 0.5 C, and then charged up to 0.01 C at a constant voltage (CV). Batteries with overcharge test result B were charged at a constant current (CC) up to 4.25 V at 0.5 C, and then charged up to 0.01 C at a constant voltage (CV). A battery with overcharge test result C was charged at a constant current (CC) up to 4.2 V at 0.5 C, and then charged up to 0.01 C at a constant voltage (CV). Batteries with overcharge test results D and E were charged at a constant current (CC) up to 4.1 Vat 0.5 C, and then charged up to 0.01 C at a constant voltage (CV). Next, constant current (CC) discharge was carried out at 0.5 C to 3 V. After that, the discharge capacity was measured by changing the discharge current value to 1 C, 3 C, and 5 C with the same charging conditions, a value calculated from the following Formula was taken as a discharge rate characteristic, and evaluation was performed based on the following evaluation criteria.

discharge rate characteristics (%)=(discharge capacity at 5 C/discharge capacity at 0.5 C)×100

A: 91% or more
B: from 89% to less than 91%
C: from 80% to less than 89%
D: less than 80%

TABLE 2

| | | Experimental | Experimental | Experimental | Experimental | Experimental | Experimental |
|---|---|---|---|---|---|---|---|
| | | Example | Example | Example | Example | Example | Example |
| | | 1B | 2B | 3B | 4B | 5B | 6B |
| Composition | Film | 5 | 5 | 5 | — | — | 5 |
| of | thickness of | | | | | | |
| conductive | conductive | | | | | | |
| layer | layer (μm) | | | | | | |
| | Melting point | 110 | 132 | 148 | — | — | 110 |
| | of polyolefin | | | | | | |
| | particle (° C.) | | | | | | |
| | Particle size | 4 | 3 | 1 | — | — | 4 |
| | of polyolefin | | | | | | |
| | particle (μm) | | | | | | |
| Composition | Material | PET | PET | PET | PET | PE | PE |
| of separator | (porous | | | | | | |
| | substrate) | | | | | | |
| | Film | 28 | 28 | 28 | 28 | 30 | 30 |
| | thickness | | | | | | |
| | (μm) | | | | | | |
| | Heat | 2 | 2 | 2 | 2 | 98 | 98 |
| | shrinkage | | | | | | |
| | ratio (%) | | | | | | |
| | Gurley Value | 20 | 20 | 20 | 20 | 600 | 600 |
| | (sec/100 cc) | | | | | | |
| Safety | overcharge | A | B | B | E | D | C |
| | property | | | | | | |
| Battery | Volume | A | B | B | D | D | C |
| property | energy | | | | | | |
| | density | | | | | | |
| | Discharge | A | A | A | B | C | B |
| | rate | | | | | | |
| | characteristics | | | | | | |

In Experimental Examples 1B to 3B, it was found that excellent effects can be obtained in terms of overcharge characteristics, volume energy density and discharge rate characteristics compared with Experimental Example 6B using a separator made of polyethylene and having a conductive layer. In Experimental Examples 1B to 3B, it is considered that excellent overcharge characteristics were obtained because the separator made of polyethylene terephthalate has a high melting point and melt down does not occur, in other words, the voltage does not decrease, in addition to the effect of increasing the voltage of the conductive layer (PTC layer).

It was found that Experimental Example 4B not including a conductive layer and using a separator made of polyethylene terephthalate has the same battery characteristics as Experimental Example 5B using a polyethylene separator, but is inferior in overcharge characteristics.

The disclosures of Japanese Patent Applications 2015-145840 and 2015-145948 filed on Jul. 23, 2015 are hereby incorporated by reference in their entirety.

All Documents, Patent Applications, and technical standards described herein are incorporated by reference herein to the same extent as if each of the Documents, Patent Applications, and technical standards had been specifically and individually indicated to be incorporated by reference.

### INDUSTRIAL APPLICABILITY

The lithium ion secondary battery of the present invention has high safety. In particular, this can be suitably used as a power source for a variety of portable electronic devices such as mobile phones, laptop personal computers, portable information terminals, electronic dictionaries, and game machines. When used for such an application, heat generation is suppressed even when the battery is overcharged in case of charging, and therefore, high temperature and bulging of the battery are surely prevented. The lithium ion secondary battery of the invention can also be applied to an application such as power storage or transportation equipment such as an electric car or a hybrid car.

### DESCRIPTION OF SYMBOLS

1 . . . cylindrical lithium ion secondary battery 2 . . . positive electrode plate 3 . . . negative electrode plate 4 . . . separator 5 . . . electrode group 6 . . . battery container

1. A lithium ion secondary battery, comprising:
a positive electrode;
a negative electrode; and
a separator, wherein:
the positive electrode comprises a current collector, a conductive layer formed on the current collector, and a positive electrode active material layer formed on the conductive layer,
the conductive layer comprises a conductive particle, a polymer particle, and a water-soluble polymer, and
the separator has a heat shrinkage ratio at 160° C. of 30% or less.

2. The lithium ion secondary battery according to claim 1, wherein the separator comprises a porous substrate and an inorganic particle, the porous substrate comprises two or more different resins, and the two or more different resins are selected from the group consisting of polypropylene, polyethylene, polyvinyl alcohol, polyethylene terephthalate, polyacrylonitrile, and aramid.

3. The lithium ion secondary battery according to claim 2, wherein the porous substrate comprises polyethylene and polypropylene.

4. The lithium ion secondary battery according to claim 1, wherein a Gurley value of the separator is 1,000 sec/100 cc or less.

5. The lithium ion secondary battery according to claim 1, wherein the separator comprises a porous substrate and an inorganic particle, and the porous substrate comprises polyester.

6. The lithium ion secondary battery according to claim 5, wherein the polyester comprises polyethylene terephthalate.

7. The lithium ion secondary battery according to claim 1, wherein the polymer particle comprises a polyethylene particle.

8. The lithium ion secondary battery according to claim 1, wherein a content ratio of a mixture of particles comprising the conductive particle and the polymer particle, and the water-soluble polymer, is from 99.9:0.1 to 95:5 in terms of mass ratio (mixture of particles:water-soluble polymer).

9. The lithium ion secondary battery according to claim 1, wherein a content ratio of the conductive particle and the polymer particle is from 2:98 to 20:80 in terms of mass ratio (conductive particle:polymer particle).

10. A lithium ion secondary battery, comprising:
a positive electrode;
a negative electrode; and
a separator, wherein:
the positive electrode comprises a current collector, a conductive layer formed on the current collector, and a positive electrode active material layer formed on the conductive layer,
the conductive layer comprises a conductive particle, a polymer particle, and a water-soluble polymer, and
the separator comprises a porous substrate and an inorganic particle, and the porous substrate comprises a layered body in which polypropylene and polyethylene are alternately layered.

11. A lithium ion secondary battery, comprising:
a positive electrode;
a negative electrode; and
a separator, wherein:
the positive electrode comprises a current collector, a conductive layer formed on the current collector, and a positive electrode active material layer formed on the conductive layer,
the conductive layer comprises a conductive particle, a polymer particle, and a water-soluble polymer, and
the separator comprises an inorganic particle and a porous substrate including a woven or non-woven fabric of polyethylene terephthalate.

12. The lithium ion secondary battery according to claim 2, wherein the inorganic particle is at least one of aluminum oxide (Al2O3) or silicon oxide (SiO2).

13. The lithium ion secondary battery according to claim 2, wherein the separator comprises a layer containing the inorganic particle on one surface of the porous substrate, and the layer containing the inorganic particle faces the positive electrode.

14. The lithium ion secondary battery according to claim 1, wherein the separator has a thickness of from 5 μm to 100 μm.

15. The lithium ion secondary battery according to claim 1, wherein the conductive layer has a thickness of from 0.1 μm to 10 μm.

16. The lithium ion secondary battery according to claim 10, wherein the inorganic particle is at least one of aluminum oxide (Al2O3) or silicon oxide (SiO2).

17. The lithium ion secondary battery according to claim 11, wherein the inorganic particle is at least one of aluminum oxide (Al2O3) or silicon oxide (SiO2).

18. The lithium ion secondary battery according to claim 10, wherein the separator comprises a layer containing the inorganic particle on one surface of the porous substrate, and the layer containing the inorganic particle faces the positive electrode.

19. The lithium ion secondary battery according to claim 11, wherein the separator comprises a layer containing the inorganic particle on one surface of the porous substrate, and the layer containing the inorganic particle faces the positive electrode.

20. The lithium ion secondary battery according to claim 10, wherein the separator has a thickness of from 5 μm to 100 μm.

21. The lithium ion secondary battery according to claim 11, wherein the separator has a thickness of from 5 μm to 100 μm.

22. The lithium ion secondary battery according to claim 10, wherein the conductive layer has a thickness of from 0.1 μm to 10 μm.

23. The lithium ion secondary battery according to claim 11, wherein the conductive layer has a thickness of from 0.1 μm to 10 μm.
